(19) United States
(12) Patent Application Publication
(10) Pub. No.: US 2007/0011673 A1
(43) Pub. Date: Jan. 11, 2007

(54) Integrated installation procedure for multiple installation sets

(75) Inventors: Eduardo D. Melo, Bellevue, WA (US); Gerald Gregory Atkinson, Renton, WA (US); Mark Anthony Yuhas II, Bellevue, WA (US); Oluwadara O. Adekanmbi, Sammamish, WA (US); Saif Hasan, Redmond, WA (US)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(73) Assignee: Microsoft Corporation, Redmond, WA (US)

(21) Appl. No.: 11/177,139

(22) Filed: Jul. 8, 2005

(51) Int. Cl. G06F 9/445

(52) U.S. Cl. 717/174

(57) ABSTRACT

A method for installing an updated software application onto the client computer from an original installation set and an update installation set is presented. The method comprises obtaining the original installation set that includes components which, when installed on the client computer, form the original software application. The original software application is installed from the original installation set. The installation uses a product key that includes installation information indicating whether an update installation set is available. A determination is made, according to the installation information in the product key, as to whether an update installation set is available. If it is determined that an update installation set is available, the update installation set is obtained. The update installation set includes components that form the updated software application when installed. The updated software application is then installed onto the client computer from the update installation set.

### BACKGROUND

In the realm of software distribution, creating a master for generating distributable media is expensive and time consuming. A software provider invests substantial time and testing to assure that the master source (programs, data files, settings, etc.) to be included on the master is as error-free as possible. Even after the master source is determined, there are additional costs in actually creating the master that will be used as the source of the distributable media. Thus, in order to drive down costs, a software provider must usually create a large run of distributable media from a single master.

While it would be wonderful if the original master source (and thus, the original master) were sufficient for the life of the software application, those skilled in the art realize that the nature of software is that there are almost always updates to the software, updates that add features, support new hardware, and the like. Thus, the original master soon becomes obsolete.

Rather than generating a new master that contains the components of the updated software application, many software providers will put the updates on a second set of distributable media, also referred to as an installation set (more particularly, the update installation set). In effect, the updated software application is then delivered on two sets of media: the original installation set, and the update installation set. However, this requires the user to first install the original installation set, and then install the update installation set. To the user, this process appears as two distinct software installations for one product, even though the software application is sold as a single product.

FIG. 1 is a pictorial diagram illustrating the typical installation process of an updated software application 110. The original software application's components 102 are placed on distributable media (duplicated from the original master), referred to as the original installation set 104. Update components 106 (developed some time after the original installation set 104 is created), that are used to convert the original software application into the updated software application, are placed on a second set of distribution media, referred to as the update installation set 108.

During installation, the original installation process 112 (associated with the original installation set 104) is executed, which installs the original software components 102 onto the client computer 116. Typically, the installation process 112 executes in conjunction with a product key 114. As those skilled in the art will appreciate, the product key 114 is used to ensure that only authorized installations are made. Typically, the product key 114 is unique for each installation.

After the original installation process 112 is completed and the original software application is installed on the client computer 116, the user then executes the update installation process 118 associated with the update installation set 108. The update installation process 118 installs the update components 106 onto the original software application installed on the client computer 116. The original product key 114, used to install the original installation set 104, is typically used.

There are legitimate reasons that software providers distribute their products, especially updated software applications, in multiple installation sets. One reason, as already discussed, is the cost of mastering the product is prohibitive if a master must be generated for each update version, thus providing a substantial incentive to a software provider to extend the life of the original master. Another reason is that, quite frequently, the original installation set may be at its payload capacity, i.e., that additional update components cannot fit on the original installation set, thus necessitating that an update installation set is used to deliver the updates.

Another issue related to delivering software application updates is that, while software providers know that the software application will be updated, at the time that the original master 104 is generated, the updates are undefined and unknown. Thus, even though they know that the software application will most likely be modified, they do not necessarily know what form the modifications will take, and therefore, are not able to adequately prepare for the updates.

As seen from the discussion above, while it is advantageous and cost-effective to distribute an updated software application using both the original and the update installation sets, it would be desirable that their installation appear as the same installation, i.e., an integrated installation process.

### SUMMARY

A computer-readable medium bearing computer-executable instructions is presented. When executed on a computer system, the computer-executable instructions carry out a method for installing an updated software application onto the client computer from an original installation set and an update installation set. The method comprises the following steps. The original installation set is obtained. The original installation set includes components, which, when installed on the client computer, form the original software application. The original software application is installed onto the client computer from the original installation set. The installation uses a product key that includes installation information indicating whether an update installation set is available. A determination is made as to whether an update installation set is available. This determination is made according to the installation information in the product key. If it is determined that an update installation set is available, the update installation set is obtained. The update installation set includes components which, when installed onto the original software application, form the updated software application. The updated software application is then installed onto the client computer from the update installation set.

A method for installing an updated software application onto a client computer from an original installation set and an update installation set is also presented. The method comprises the following steps. The original installation set, including components which, when installed on the client computer, form the original software application, is obtained. The original software application is installed onto the client computer from the original installation set. The installation uses a product key that includes encrypted information, including installation information indicating whether an update installation set is available. The product key is decrypted and a determination is made as to whether an update installation set is available according to the decrypted installation information. If it is determined that an update installation set is available, the update installation set is obtained. The update installation sets includes components which, when installed onto the original software application, form the updated software application. The updated software application is then installed onto the client computer from the update installation set.

A computer-readable medium bearing computer-executable instructions is further presented. When executed on a computer system, the computer-executable instructions carry out a method for installing an updated software application onto the client computer from an original installation set and an update installation set. The method comprises the following steps. The original installation set, including components, which, when installed on the client computer, form the original software application, is obtained. A product key, for use in installing the updated software application onto the client computer, is obtained. The product key includes encrypted information, including installation information, that indicates whether an update installation set is available in addition to the original installation set. The original software application is installed onto the client computer from the original installation set using the product key. The installation information is decrypted from the product key, and, according to the decrypted installation information, a determination is made as to whether an update installation set is available. If it is determined that an update installation set is available, the update installation set, including components, which, when installed onto the original software application, form the updated software application, is obtained. The updated software application is then installed onto the client computer from the update installation set.

### BRIEF DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 is a pictorial diagram illustrating a typical installation process of an updated software application onto a client computer;

FIG. 2 is a pictorial diagram illustrating an exemplary computer system suitable for implementing an integrated installation process over multiple installation sets, and further illustrating extracting installation information from a product key for determining whether an updated installation set is available;

FIG. 3 is a pictorial diagram illustrating aspects of an exemplary integrated installation process of an updated software application onto a client computer delivered on both original and update installation sets; and

FIGS. 4A and 4B are a flow diagram illustrating an exemplary routine, implemented on a client computer, for implementing an integrated installation process including multiple installation sets.

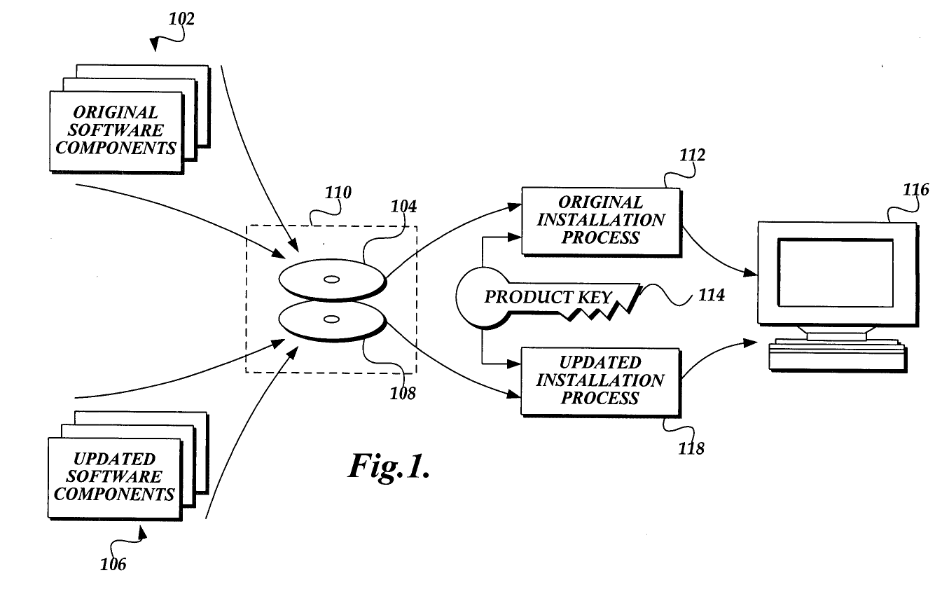

### DETAILED DESCRIPTION

In order to better describe and present the integrated installation process over multiple installation sets, the following definitions are set forth.

The term “original software application” refers to the software application which forms the basis of the updated software application, i.e., before the updates are applied. Correspondingly, the term “updated software application” refers to the product of the original software application after applying the updates of an update installation set.

The term “original installation set” refers to a set of installation files and/or data from which the original software application may be installed onto a client computer. Typically, the original installation set is duplicated onto distribution media, such as an optical disk, a magnetic disk, magnetic tape, and the like. However, it should be appreciated that the original installation set (and/or update installation set) may also be a collection of files and/or data on a fixed disk drive associated with the client computer, or alternatively, on a network-accessible drive, or an Internet location. Thus, while subsequent references to the original installation set may be made with regard to an installation set on an optical disk (or disks), it is for simplicity purposes only, and should not be construed as limiting upon the present invention.

The term “update installation set” refers to a set of installation files and/or data from which the updates (either as software fixes or version updates) are applied to an original software application installed on a client computer. The update installation set, as with the original installation set, may be delivered on removable media (optical disks, magnetic tape, and the like) or as files and/or data located locally or remotely to the client computer. Of course, the update installation set may include features that fix problems with or extend the functionality of the original software application, but the scope of the present invention is not so limited. In fact, an integrated installation procedure for multiple installation sets may be beneficially applied in a number of circumstances. For example, the update installation set may include features specific to a particular customer segment or niche, such as small businesses, physically impaired users, the legal market, and the like. Similarly, the update installation set may deliver a payload designed to modify the original software application for needs of a particular country and/or language. Even further, an update installation set may deliver components designed to complement the original installation set, such as complementary applications from third party vendors or ISVs.

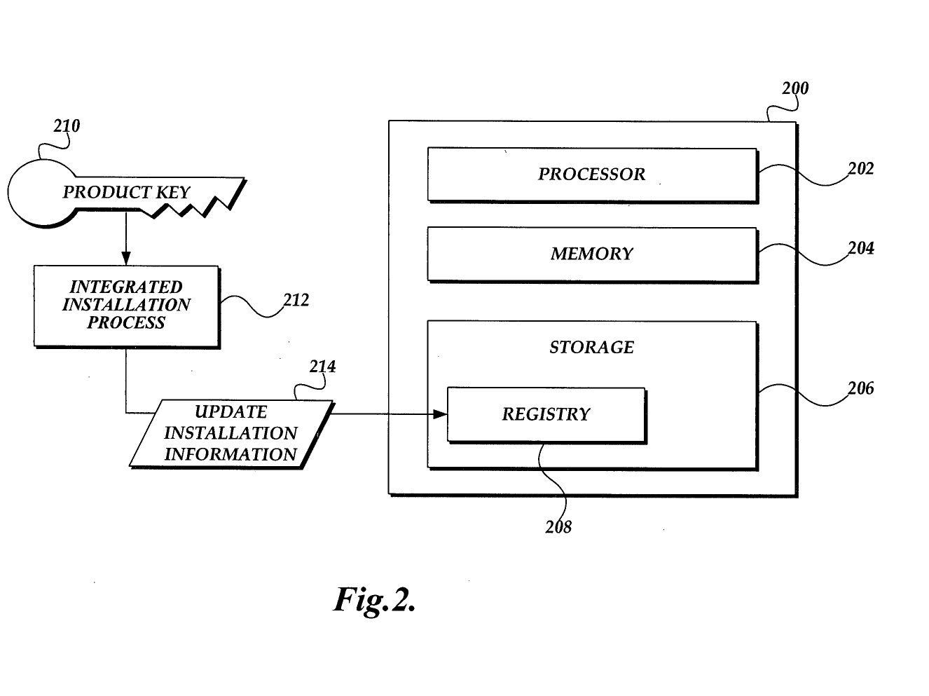

FIG. 2 is a pictorial diagram illustrating an exemplary computer system 200 suitable for implementing an integrated installation procedure. As shown in FIG. 2, the exemplary computer system includes a processor 202 and a memory 204, the memory including random access memory (RAM), cache memory, and read-only memory (ROM). The processor 202 executes computer-executable instructions from memory 204, which are typically retrieved to memory from various computer-accessible locations including a local storage 206 such as a fixed hard drive, a removable media drive, a network drive connected to the computer via a LAN or WAN, and the like.

In light of the above, the integrated installation procedure should be considered as implementable on any number of computing systems that are susceptible to software installation, including, but not limited to, personal computers, notebook and laptop computers, mini- and mainframe computers, personal digital assistants (PDA), hybrid PDA-mobile phone combinations, and the like.

In order to provide for an integrated installation procedure including an original installation set and one or more update installation sets, information indicating that one or more updated installation sets are available is embedded in the product key 210.

With regard to the product key 210, in general terms, the product key is used during an installation process, such as the integrated installation process 212, to ensure that the installation is an authorized installation. In other words, the product key 210 represents a code, which, if proven valid during the installation process, authenticates whether the user is authorized to install the corresponding software components.

According to aspects of the present invention, during the integrated installation process 212, the product key 210 is decrypted using a predetermined algorithm. The resultant decrypted information is examined to determine whether the product key 210 is valid, thereby implying an authorized installation. Without a valid product key, the integrated installation process 212 ceases installing the software application. If the product key 210 is valid, the software application is installed on the client computer, and update installation information 214 is identified in the decrypted information. This update installation information indicates whether one or more additional update installation sets are available. Based on this update installation information, additional steps may be executed in the installation procedure, additional installation procedures may be executed, and the like. In one embodiment, after the update installation information is decrypted from the product key, it is stored in the computer system's storage 206, such as in the system registry 208.

One of the advantages of including an indication whether or not one or more update installation sets are available is that the same integrated installation process 212 can be used for installing the original software application as well as the updated software application. A product key 210 corresponding only to the original software application may be generated with the update installation information indicating that no additional update installation set is available. Yet for an updated software application, a product key, using the same format as the product key for the original software application, may be generated with the update installation information 214 indicating that one or more update installation sets are available. In effect, this enables the integrated installation process 212 to install both the original installation set and one or more update installation sets.

While the present discussion is made with regard to a product key providing information indicating that an additional update installation set is available, such information may be provided without the use of a product key. For example, the original installation process may query the computer system for particular settings that would indicate that an additional update installation set may be provided. Such information may be based on a default language (Japanese, Spanish, English, etc.) installed on the computer system, whether special features for assisting physically impaired user are present, whether the computer system is configured to a niche market, and the like. Accordingly, including information in the product key 210 indicating that an additional update installation set is available should be viewed as illustrative only, and not construed as limiting upon the present invention.

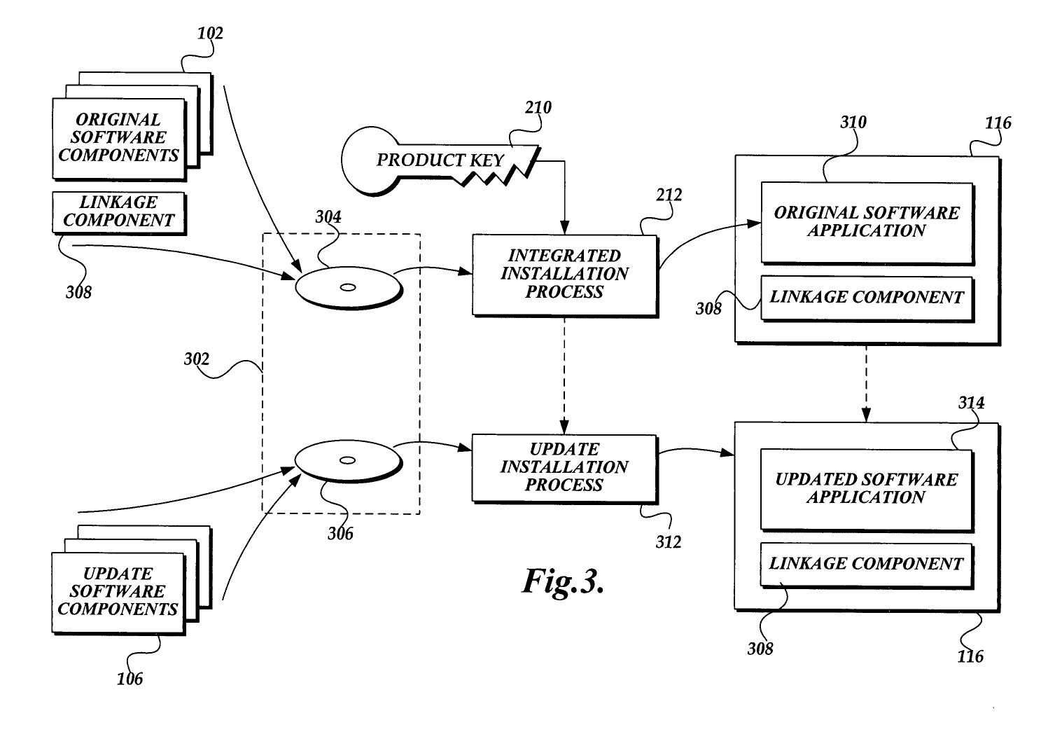

FIG. 3 is a pictorial diagram illustrating aspects of an exemplary integrated installation process of an updated software application 302 (comprising both original software components 102 and update software components 106) onto a client computer 116, where the updated software application is delivered on both an original installation set 304 and an update installation set 306.

In addition to including update installation information in the product key 210, which indicates whether one or more update installation sets are available, a linkage component 308 is included, typically with the original software components 102 on the original installation set 304. The linkage component 308 is installed on the client computer 116 in conjunction with the original software application 310.

As discussed above, during the integrated installation process 212 (FIG. 2) of the original software application 310, update installation information 214 (FIG. 2) from the product key 210 is checked to see if one or more update installation sets are available. If the update installation information 214 indicates that one or more update installation sets are available, after installing the original software application 310, the integrated installation process 212 continues by executing the linkage component 308. To continue the installation of the one or more update installation sets, according to one embodiment, the linkage component 308 automatically executes an update installation process 312 associated with an update installation set. The update installation process 312 updates the original software application on the client computer 116, resulting in the updated software application 314.

With regard to the linkage component 308, while it is illustrated as a separate component from the integrated installation process 212, this separation is a logical separation, and may or may not be an actual, physical separation. In one embodiment, the linkage component is a logical component of the integrated installation process 212, i.e., it is an internal function called at the end of the integrated installation process. What is important is that a linkage component 308, whether or not it is part of the integrated installation process 212, automatically continues the installation of the one or more update installation sets by executing the update installation process 312. If the linkage component 308 is an actual component separate from the integrated installation process, it is not necessary that the linkage component is installed in the same location with the original software application 310. Additionally, the linkage component 308 may be used to install multiple update installation sets.

Similarly, in alternative embodiments, while the update installation process 312 is illustrated as a separate process, this, too, may be included as part of the integrated installation process 212. Of course, due to the unknown nature of the updates in regard to the update installation set 306, and also due to the fact that the integrated installation process 212 was determined at the time of creating the original installation set 302, the update installation process 312 can be more fully tailored to the update installation set 306 if it is a separate component, tailored to and included with the update installation set.

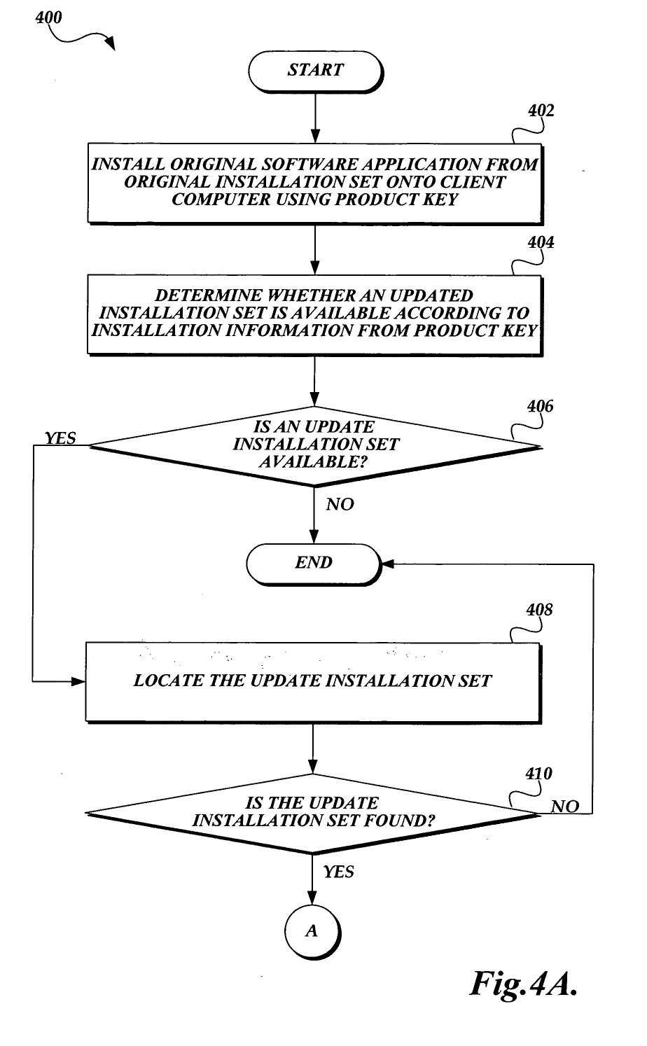

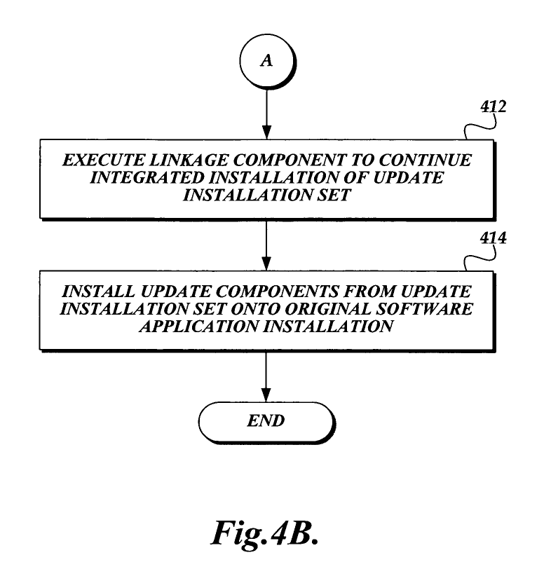

FIGS. 4A and 4B are a flow diagram illustrating an exemplary routine 400 for carrying out an integrated installation process including multiple installation sets. Beginning at block 402, the original software application 310 is installed from the original installation set 304 onto a client computer 116 using a product key 210. At block 404, it is determined whether an update installation set 306 is available according to installation information 214 from the product key 210.

At decision 406, the exemplary routine 400 proceeds to block 408 if the installation information 214 from the product key 210 indicates that there is an update installation set 306 to be installed on the client computer 116. Otherwise, the routine 400 terminates.

At block 408, an effort is made to locate the update installation set 306. For example, the drive from where the original installation set 304 was launched may be queried, the user may be presented with a query, asking for the location of the update installation set 306, and the like. At decision 410, the exemplary routine 400 terminates if the update installation set 306 is not located. Alternatively, if the update installation set 306 is located, the routine 400 proceeds to block 412 (FIG. 4B).

At block 412, the linkage component 308 is executed to continue the integrated installation of the update installation set 306. At block 414, the update components on the update installation set 306 are installed onto the installed original software application 310 resulting in an updated software application 314. Thereafter, the routine 400 terminates.

While the exemplary routine 400 describes locating a single update installation set 306, it should be appreciated that in an alternative embodiment, the exemplary routine repeatedly queries whether additional update installation sets are available, and, if so, installs the contents of the update installation sets until they have all been installed.

While various embodiments, including the preferred embodiment, of the present invention have been illustrated and described, it will be appreciated that various changes can be made therein without departing from the spirit and scope of the invention.

The embodiments of the invention in which an exclusive property or privilege is: claimed are defined as follows:

1. A computer-readable medium bearing computer-executable instructions which, when executed on a computer system, carry out a method for installing an updated software application onto the client computer from an original installation set and an update installation set, the method comprising:
obtaining the original installation set including components which, when installed on the client computer, form the original software application;
installing the original software application onto the client computer from the original installation set using a product key, wherein the product key includes installation information indicating whether an update installation set is available;
determining whether an update installation set is available according to the installation information in the product key; and
if it is determined that an update installation set is available:
obtaining the update installation set including components which, when installed onto the original software application, form the updated software application; and
installing the updated software application onto the client computer from the update installation set.

2. The computer-readable medium of claim 1, wherein the method further comprises, if it is determined that an update installation set is available, executing a linkage component that obtains the update installation set and installs the updated installation application onto the client computer from the update installation set.

3. The computer-readable medium of claim 2, wherein the original installation set further includes the linkage component, and where the linkage component is installed on the client computer with the installation of the original software application.

4. The computer-readable medium of claim 3, wherein the linkage component executes an update installation process associated with the update installation set to install the updated software application onto the client computer.

5. The computer-readable medium of claim 4, wherein the update installation process is located with the update installation set.

6. The computer-readable medium of claim 4, wherein the method further comprises, if it is determined that an update installation set is available, locating the update installation set, and installing the updated application software only if the update installation set is located.

7. The computer-readable medium of claim 4, wherein the product key contains encrypted information, and the installation information is decrypted from the product key during installation of the original software application.

8. The computer-readable medium of claim 7, wherein the decrypted installation information is stored in the client computer's system registry.

9. A method for installing an updated software application onto a client computer from an original installation set and an update installation set, the method comprising:
obtaining the original installation set including components which, when installed on the client computer, form the original software application;
installing the original software application onto the client computer from the original installation set using an encrypted product key, wherein the product key includes encrypted information including installation information indicating whether an update installation set is available;
decrypting the product key and determining whether an update installation set is available according to the decrypted installation information; and
if it is determined that an update installation set is available:
obtaining the update installation set including components which, when installed onto the original software application, form the updated software application; and
installing the updated software application onto the client computer from the update installation set.

10. The method of claim 9 further comprising executing a linkage component that obtains the update installation set and installs the updated installation application onto the client computer from the update installation set if it is determined that an update installation set is available.

11. The method of claim 10, wherein the original installation set further includes the linkage component that is installed on the client computer with the installation of the original software application.

12. The method of claim 11, wherein the linkage component executes an update installation process located on the update installation set to install the updated software application onto the client computer.

13. The method of claim 12 further comprising, if it is determined that an update installation set is available, attempting to located the update installation set, and installing the updated application software only if the update installation set is located.

14. A computer-readable medium bearing computer-executable instructions which, when executed on a computer system having a processor, memory, and a storage, implement a method for installing an updated software application onto the client computer from an original installation set and an update installation set, the method comprising:
obtaining the original installation set including components which, when installed on the client computer, form the original software application;
obtaining a product key for use in installing the updated software application onto the client computer, wherein the product key includes encrypted information including installation information that indicates whether an update installation set is available in addition to the original installation set;
installing the original software application onto the client computer from the original installation set using the product key;
decrypting the installation information from the product key and determining whether an update installation set is available according to the decrypted installation information; and
if it is determined that an update installation set is available:
obtaining the update installation set including components which, when installed onto the original software application, form the updated software application; and
installing the updated software application onto the client computer from the update installation set.

15. The computer-readable medium of claim 14, wherein the method further comprises executing a linkage component that obtains the update installation set and installs the updated installation application onto the client computer from the update installation set if it is determined that an update installation set is available.

16. The computer-readable medium of claim 15, wherein the linkage component that is installed from the original installation set onto the client computer with the installation of the original software application.

17. The computer-readable medium of claim 16, wherein the linkage component executes an update installation process located on the update installation set to install the updated software application onto the client computer.

18. The computer-readable medium of claim 17, the method further comprising, if it is determined that an update installation set is available, attempting to located the update installation set, and installing the updated application software only if the update installation set is located.

19. The computer-readable medium of claim 18, wherein the update installation set and the original installation set are located on computer-readable media.

20. The computer-readable medium of claim 18, wherein the update installation set and the original installation set are located on a remote network accessible storage device.
